(19) United States
(12) Patent Application Publication
(10) Pub. No.: US 2022/0196609 A1
(43) Pub. Date: Jun. 23, 2022

(54) HIGH TEMPERATURE MAGNETIC ATTACHMENT FOR ULTRASONIC PROBES

(71) Applicant: Baker Hughes Oilfield Operations LLC, Houston, TX (US)

(72) Inventor: Eric Edward Klaben, Marcellus, NY (US)

(21) Appl. No.: 17/539,780

(22) Filed: Dec. 1, 2021

Related U.S. Application Data
(60) Provisional application No. 63/127,992, filed on Dec. 18, 2020.

(51) Int. Cl. G01N 29/24; G01N 29/22

(52) U.S. Cl. CPC G01N 29/24; G01N 29/227; G01N 29/228

(57) ABSTRACT

An ultrasonic probe assembly includes an ultrasonic probe having a housing, an ultrasonic sensor, at least one magnet, and rotatable joint portions. The housing extends along a longitudinal axis between first and second ends and includes a base surface. The sensor is secured adjacent a housing base surface configured to emit ultrasonic signals and receive ultrasonic echoes reflected from a target. The magnet is secured within the housing and configured to apply a magnetic force urging the base surface into contact with a surface of the target. The magnetic force frictionally maintains the housing at a stationary position with respect to the target surface. A first rotatable joint portion is positioned on a first lateral side of the housing. A second rotatable joint portion is positioned on a second lateral side of the housing, opposite the first lateral side.

### CROSS-REFERENCE TO RELATED APPLICATIONS

This application claims the benefit of U.S. Provisional Patent Application No. 63/127,992, filed on Dec. 18, 2020, and entitled “High Temperature Magnetic Attachment For Ultrasonic Probes,” the entirety of which is incorporated by reference.

### BACKGROUND

Non-destructive testing (NDT) is a class of analytical techniques that can be used to inspect characteristics of a target, without causing damage, to ensure that the inspected characteristics satisfy required specifications. For this reason, NDT can be used in a number of industries such as aerospace, power generation, oil and gas transport or refining. NDT can be useful in industries that employ structures that are not easily removed from their surroundings (e.g., pipes) or where failures would be catastrophic.

Ultrasonic testing is one type of NDT. Ultrasound is acoustic (sound) energy in the form of waves that have an intensity (strength) which varies in time at a frequency above the human hearing range. In ultrasonic testing, an ultrasonic probe can generate one or more ultrasonic waves and these waves can be directed towards a target in an initial pulse. As the ultrasonic waves contact and penetrate the target, they can reflect from features such as outer surfaces and interior defects (e.g., cracks, porosity, etc.). The ultrasonic probe can also acquire ultrasonic measurements, acoustic strength as a function of time that characterize these reflected ultrasonic waves. Subsequently, ultrasonic measurements can be analyzed to determine target characteristics.

### SUMMARY

Additional challenges are encountered when performing ultrasonic testing in high temperature environments. While fluid couplants are often employed in ultrasonic testing to facilitate transmission of ultrasonic signals between the ultrasonic probe and the target, these couplants can rapidly evaporate under high temperature conditions. Accordingly, high temperature ultrasonic testing can omit the use of liquid couplants and instead rely upon contact between the ultrasonic probe and the surface of the target to provide sufficient coupling for transmission of ultrasonic signals between the ultrasonic probe and the target, referred to as dry coupling. In order to ensure adequate contact between the ultrasonic probe and the target, a downward (e.g., radial) force can be applied to the ultrasonic probe (e.g., using circumferential bands).

It can be desirable to increase the density of ultrasonic probes to provide increased coverage area and/or improved signal to noise ratio of detected ultrasonic echoes. While the use of bands to provide downward force on the ultrasonic probe can be adequate when a relatively small number of ultrasonic probes are used, problems can arise when the number of ultrasonic probes is increased. As an example, if the downward force is not properly distributed amongst the ultrasonic probes, the downward force applied to a given ultrasonic probe can be too high or too low. A downward force that is too high can result in damage to the ultrasonic probe, while a downward force that is too low can result in inadequate contact between the ultrasonic probe and the target.

These problems with bands can be more prevalent in high temperature environments. In general, materials expand with increasing temperature. Furthermore, different materials expand by different amounts, referred to as differential thermal expansion. Thus, differential thermal expansion between the bands and the target can also result in the downward force applied to a given ultrasonic probe being too high or too low.

Other solutions have been developed to avoid the use of bands to apply downward force. As an example, a mount can be employed with a first component coupled (e.g., welded) to the surface of the target and a second component coupled to the ultrasonic probe. The first and second components can be configured to mate with one another to secure the ultrasonic probe in contact with the target. However, welding presents significant limitations. In one aspect, ultrasonic testing can be limited to the location of the weld(s). In another aspect, welding can be costly and time consuming. In a further aspect, welding can cause unintended damage to the target.

Accordingly, there exists an ongoing need for improved systems and methods to facilitate dry coupling of ultrasonic probes to targets, in particular under high temperature conditions.

In an embodiment, an ultrasonic probe assembly is provided that includes an ultrasonic probe. The ultrasonic probe can include a housing, an ultrasonic sensor, at least one magnet, a first rotatable joint portion and a second rotatable joint portion. The ultrasonic probe can include a housing extending along a longitudinal axis between a first end and a second end and including a base surface. The ultrasonic sensor can be secured adjacent to the base surface of the housing, and the ultrasonic sensor can be configured to emit ultrasonic signals and receive ultrasonic echoes reflected from a target. The at least one magnet can be secured within the housing and it can be configured to apply a magnetic force urging the base surface into contact with a surface of the target. The magnetic force can be sufficient to frictionally maintain the housing at a stationary position with respect to the target surface. The first rotatable joint portion can be positioned on a first lateral side of the housing. The second rotatable joint portion can be positioned on a second lateral side of the housing, opposite the first lateral side.

In an embodiment, the ultrasonic probe assembly can further include a first ring. The first ring can be formed from a first plurality of the ultrasonic probes coupled together by respective first rotatable joints. The first rotatable joints can be formed by the first rotatable joint portion and the second rotatable joint portion of adjacent ones of the first plurality of ultrasonic probes. Each ultrasonic probe of the first plurality of ultrasonic probes can be positioned at about predetermined radial position with respect to a center of the first ring.

In an embodiment, the ultrasonic probe assembly can further include a second ring. The second ring can be formed from a second plurality of the ultrasonic probes coupled together by respective second rotatable joints. The second rotatable joints can be formed by the first rotatable joint portion and the second rotatable joint portion of adjacent ones of the second plurality of ultrasonic probes. At least a portion of, and up to all of, the ultrasonic probes of the second plurality of ultrasonic probes can be positioned at a predetermined radial position with respect to a center of the second ring.

In an embodiment, at least a portion of, and up to all, of the ultrasonic probes of the first and second plurality of ultrasonic probes, can also include at least one of a third rotatable joint portion positioned on the first end of the housing and a fourth rotatable joint portion positioned on the second end of the housing.

In an embodiment, the first ring and the second ring can be coupled together by respective third rotatable joints. The third rotatable joints can be formed by the third rotatable joint portion and the fourth rotatable joint portion of adjacent ones of the first and second plurality of ultrasonic probes. At least a portion of, and up to all of, the ultrasonic sensors of the ultrasonic probes of the first ring can be longitudinally distanced from a nearest longitudinally neighboring ultrasonic sensor of the ultrasonic sensors of the second ring by a predetermined longitudinal offset.

In an embodiment, a Curie temperature of the at least one magnet can be greater than or equal to 450° C.

In an embodiment, the base surface of each of the ultrasonic probes can be approximately flat.

In an embodiment, the base surface of at least a portion of the ultrasonic probes can have a radius of curvature selected to match a radius of curvature of an outer surface of the target.

In an embodiment, the magnetic force applied by the at least one magnet can be between about 100 to about 200 lbf.

In an embodiment, the housing can be formed in an approximately rectangular shape.

In an embodiment, the ultrasonic probe assembly can also include at least one biasing member extending through the base surface of the housing and configured to exert a selectively adjustable biasing force in a direction opposite the magnetic force when the base surface of the housing contacts the target surface.

In another embodiment, a method for coupling an ultrasonic probe to a target is provided. The method can include placing a base surface of each of a plurality of ultrasonic probes in contact with a target having an approximately circular outer surface. The plurality of ultrasonic probes can include a housing extending along a longitudinal axis between a first end and a second end and including the base surface. The method can also include magnetically securing each of the plurality of ultrasonic probes to the target by at least one magnet positioned within the ultrasonic probe housing. The method can further include forming a first ring from a first plurality of ultrasonic probes. The first ring can include laterally adjacent first pairs of the first plurality of the ultrasonic probes rotatably coupled by first rotatable joints. The first rotatable joints can include a first rotatable joint portion positioned on a first lateral side of one of the first pair and a second rotatable joint portion positioned on a second lateral side of the other of the first pair, opposite the first lateral side. At least a portion of the first plurality of ultrasonic probes can be positioned at a predetermined radial position with respect to a center of the first ring.

In an embodiment, the method can further include emitting an ultrasonic signal from one or more of the first plurality of ultrasonic probes, the ultrasonic signal being emitted by an ultrasonic sensor secured adjacent to the base surface of the housing.

In an embodiment, the method can further include forming a second ring from a second plurality of the ultrasonic probes. The second ring can include laterally adjacent second pairs of the second plurality of ultrasonic probes rotatably coupled by second rotatable joints. The second rotatable joints can include a first rotatable joint portion positioned on a first lateral side of one of the second pair and a second rotatable joint portion positioned on a second lateral side of the other of the second pair, opposite the first lateral side. At least a portion of the second plurality of ultrasonic probes can be positioned at a predetermined radial position with respect to a center of the second ring.

In an embodiment, the method can further include axially coupling the first and second rings by respective third rotational joints. The third rotational joints can be formed by a third rotatable joint portion positioned at a first end of the first plurality of ultrasonic probes and a fourth rotatable joint portion positioned at a second end of the second plurality of ultrasonic probes.

In an embodiment, at least a portion of the ultrasonic probes of the first ring can be longitudinally distanced from a nearest neighbor ultrasonic probe of the second ring by a predetermined longitudinal offset.

In an embodiment, the magnetic force applied by the at least one magnet can be approximately constant up to temperature of about 450° C.

In an embodiment, the method can include applying a selectively adjustable biasing force that opposes the magnetic force when the base surface of the housing contacts the target surface.

In an embodiment, a fluid couplant is not interposed between the surface of the target and the base surface of the plurality of ultrasonic probes.

### DESCRIPTION OF DRAWINGS

These and other features will be more readily understood from the following detailed description taken in conjunction with the accompanying drawings, in which:

FIG. 1A is a diagram illustrating one exemplary embodiment of an operating environment including an ultrasonic testing system having a plurality of dry coupling ultrasonic probes configured for dry coupling to a target (e.g., a pipe);

FIG. 1B is a diagram illustrating a axial view of the dry coupling ultrasonic probes of FIG. 1A circumferentially mounted to the target;

FIG. 2A is a diagram illustrating an top-down isometric view of one exemplary embodiment of a dry coupling ultrasonic probe of the system of FIGS. 1A-1B;

FIG. 2B is a diagram illustrating a bottom-up isometric view of the dry coupling ultrasonic probe of FIG. 2A;

FIG. 3 is a diagram illustrating an isometric view of a plurality of the dry coupling ultrasonic probes of FIGS. 2A-2B circumferentially mounted to the target as a ring having a single row;

FIG. 4A is a diagram illustrating an isometric view of the dry coupling ultrasonic probes of FIGS. 2A-2B circumferentially mounted to the target in two rows coupled together;

FIG. 4B is a diagram illustrating a side view of the dry coupling ultrasonic probes of FIG. 4A;

FIG. 5A is a top-down isometric view of an alternative embodiment of a dry coupling ultrasonic probe configured for dry coupling to a target and that includes a curved base surface;

FIG. 5B is a bottom-up isometric view of the dry coupling ultrasonic probe of FIG. 5A;

FIG. 5C is a schematic drawing illustrating a cover of the dry coupling ultrasonic probe of FIG. 5A; and

FIG. 6 is a flow diagram illustrating one exemplary embodiment of a method for method for coupling an ultrasonic probe to a target.

It is noted that the drawings are not necessarily to scale. The drawings are intended to depict only typical aspects of the subject matter disclosed herein, and therefore should not be considered as limiting the scope of the disclosure.

### DETAILED DESCRIPTION

There is a need to monitor assets at high temperatures using ultrasonic sensors. There is also a need to attach these ultrasonic sensors without the use of clamps. An improved ultrasonic probe is provided that includes a housing and one or more magnets designed to apply a magnetic force that urges the ultrasonic probe towards the target. The housing further includes coupling mechanisms that allow neighboring ultrasonic probes to be attached to one another. The combination of magnetic force and coupling mechanisms allows a suitable downward force to be applied to the ultrasonic probe to achieve acoustic coupling without use of a fluid couplant between the ultrasonic probe and the target. This allows ultrasonic measurements to be acquired by the ultrasonic probe without the use of clamps at extreme temperatures (e.g., up to about 450° C.).

Embodiments of sensing systems and corresponding methods for coupling an ultrasonic probe to a target are discussed herein. Embodiments of the disclosure are discussed in the context of targets in the form of pipes. However, the disclosed embodiments can be employed with targets having other shapes (e.g., curved or flat) without limit.

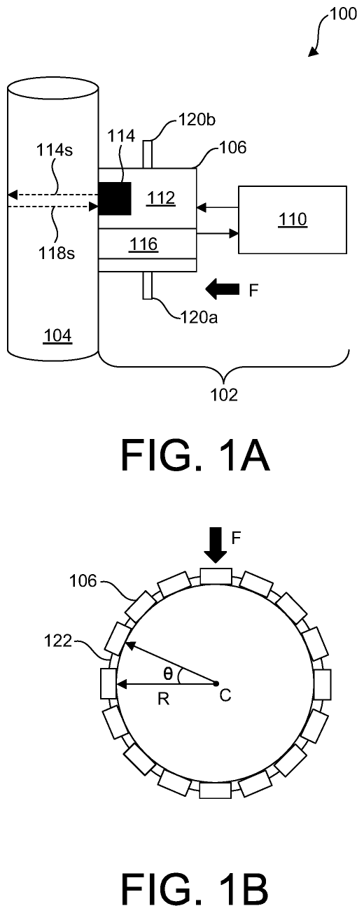

FIG. 1 illustrates one exemplary embodiment of an operating environment 100 containing a dry coupling ultrasonic testing system 102 and a target 104 (e.g., a tube). The dry coupling ultrasonic testing system 102 can include a dry coupling ultrasonic probe 106 in communication with an analyzer 110. The dry coupling ultrasonic probe 106 can include a housing 112, at least one ultrasonic sensor 114, at least one magnet 116, a first rotatable joint portion 120a, and a second rotatable joint portion 120b.

The at least one ultrasonic sensor 114 can be mounted within the housing 112 and it can be configured to generate ultrasonic waves that penetrate the target 104 at a selected angle and strength (e.g., ultrasonic amplitude or intensity), referred to herein as incident ultrasonic signals 114s. The at least one ultrasonic sensor can also be configured to detect ultrasonic waves reflected back to the ultrasonic sensor 114 from the target 104, referred to herein as return ultrasonic signals 118s. The analyzer 110 can be configured to command the dry coupling ultrasonic probe 106 (e.g., the ultrasonic sensor 114) to emit the incident ultrasonic signals 114s and receive the return ultrasonic signals 118s. The return ultrasonic signals 118s can be further stored, analyzed by the analyzer 110 and/or transmitted to another computing device for storage and/or analysis.

In use, the dry coupling ultrasonic probe 106 can be positioned in contact with the target 104 (e.g., in contact with or near the target 104) for receiving the return ultrasonic signals 118s. As shown, the at least one magnet 116 is also mounted within the housing 112 and the ultrasonic sensor 114 is positioned adjacent (e.g., on or near) to a surface of the ultrasonic probe 106 (e.g., a base surface) that contacts the target 104. The target 104 can be a magnetic material and the at least one magnet 116 can be configured to apply a magnetic force urging the base surface of the dry coupling ultrasonic probe 106 into contact with a surface of the target 104. The magnetic force can exhibit a magnitude sufficient to frictionally maintain the housing 112 at a stationary position with respect to the target surface.

As further shown in FIGS. 1A-1B, the dry coupling ultrasonic probe 106 can include a first rotatable joint portion 120a and a second rotatable joint portion 120b on opposing sides of the dry coupling ultrasonic probe 106. The first and second rotatable joint portion 120a, 120b can be configured to couple with one another to form a rotatable joint 122. That is, adjacent dry coupling ultrasonic probes 106 can be pivotably coupled to one another. This configuration facilitates mounting a plurality of dry coupling ultrasonic probe 106 to the target 104. As shown in FIG. 1B, a ring formed from a plurality of dry coupling ultrasonic probes 106 coupled together by respective rotatable joints 122 can be fashioned.

By circumferentially coupling the dry coupling ultrasonic probes 106 together, adjacent dry coupling ultrasonic probes 106 can pivot with respect to one another, allowing at least a portion of respective dry coupling ultrasonic probes 106 to contact the target surface. In this manner, at least a portion of, and up to all of, the dry coupling ultrasonic probes 106 of the first plurality 300 of ultrasonic probes 106 can be positioned at a predetermined radius R with respect to a center C of the first ring 302. At least a portion of, and up to all of, the dry coupling ultrasonic probe 106 of the first plurality 300 of ultrasonic probes 106 can also be positioned with a predetermined circumferential separation between common reference points of the ultrasonic probes 106 (e.g., about the center of the ultrasonic sensors 114 of the ultrasonic probes 106). The circumferential separation can be an arc length given by the product of the radius R and an angle θ between the common reference points.

Beneficially, by using the at least one magnet 116 suitable for exposure to extreme temperatures and mechanical coupling of adjacent dry coupling ultrasonic probes 106 to one another, sufficient downward force can be provided to achieve acoustic coupling without liquid couplant. Furthermore, the dry coupling ultrasonic probes 106 can be retained on the surface of the target 104 without the use of clamps at extreme temperatures (e.g., up to about 450° C.).

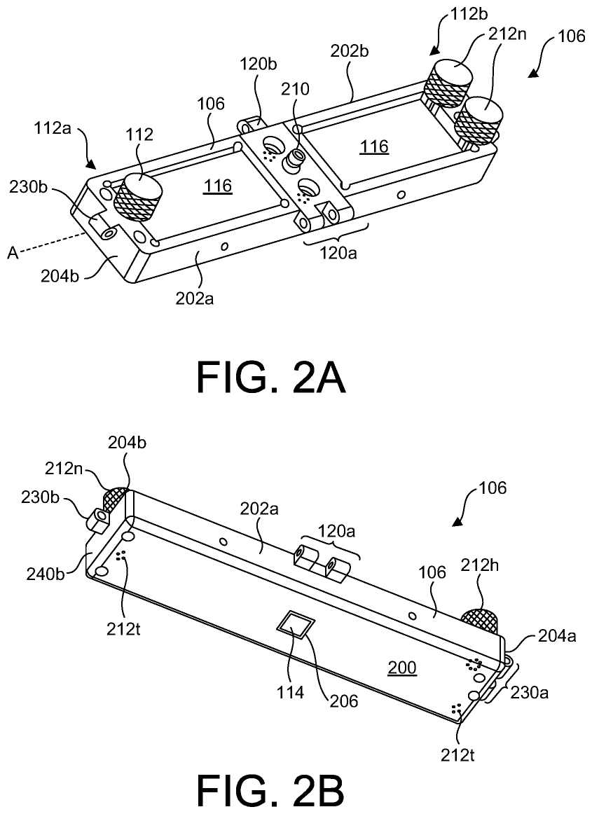

An embodiment of the dry coupling ultrasonic probe 106 is illustrated in greater detail in FIGS. 2A-2B. FIG. 2A is a top-down isometric view and FIG. 2B is a bottom-up isometric view. As shown, the housing 112 is generally elongate, extending along a longitudinal axis A between a first end 112a and a second end 112b and including a base surface 200. In certain embodiments, the shape of the housing 112 can be generally rectangular, including opposed, laterally facing sides 202a, 202b and opposed longitudinally-facing ends 204a, 204b.

In further embodiments, the base surface 200 of the housing 112 can be approximately flat. However, in other embodiments, discussed below, the housing can adopt other shapes without limit. As an example, the base surface can adopt a curvature approximately equal to a curvature of the outer surface of the target.

The ultrasonic sensor 114 can be positioned adjacent to the base surface 200 (e.g., near to or in contact with). As shown, an opening 202 is formed in the base surface 200 and the ultrasonic sensor 114 is positioned within the opening 206. As an example, a sensing surface (e.g., a surface from which the incident ultrasonic signals 114s are emitted) is approximately flush with the frame. That is, the plane of the sensing surface of the ultrasonic sensor 114 can be approximately co-planar with the base surface 200. The ultrasonic sensor 114 can be further in electrical communication with a connector 210 positioned on an upper surface of the housing 112 for output of the return ultrasonic signals 118s to the analyzer 110 via a high-temperature electrical cable (not shown).

The at least one magnet 116 can also be placed within the housing 112. As discussed above, the at least one magnet 116 are configured to provide an attractive force between themselves and the target 104 that is sufficient to frictionally maintain the housing 112 at a stationary position with respect to the target surface upon which the dry coupling ultrasonic probe 106. In certain embodiments, the magnetic field strength of the at least one magnet 116 can be about 8 kGauss to about 10 kGauss, resulting in a downward magnetic force F applied by the at least one magnet 116 that is between about 100 lbf. to about 200 lbf. (e.g., about 100 lbs. downward force).

In an embodiment, the magnetic properties of the at least one magnet 116 can be substantially constant over temperature ranges from about 25° C. to about 450° C. (e.g., about 450° C.). In further embodiments, the Curie temperature of the at least one magnet 116 can be greater than or equal to about 400° C. As an example, the Curie temperature can be within the range from about 400° C. to about 500° C. (e.g., about 450° C.).

The magnet 116 can be formed from any element or composition capable of providing the above-discussed performance parameters. Examples can include, but are not limited to, samarium cobalt (Sm₂Co₁₇).

As shown, the two magnets 116 are positioned within the housing 112, on opposite sides of the ultrasonic sensor 114 in the longitudinal direction. While two magnets are illustrated, it can be appreciated that the number of magnets can be greater or fewer and that their relative position and shape can be different than that illustrated in FIG. 2A. In additional embodiments, the housing can further include a cover (not shown) overlying the at least one magnet for protection from damage.

The dry coupling ultrasonic probe 106 can further include at least one biasing member 212. As shown in FIGS. 2A-2B, the dry coupling ultrasonic probe 106 includes three biasing members 212. However, it can be understood that embodiments of the dry coupling ultrasonic probe can include greater or fewer biasing members, as necessary.

At least a portion of, and up to all of, the at least one biasing members 212 can be a rigid bodies that extends through the base surface 200 of the housing 112 and can be configured to exert a selectively adjustable biasing force in a direction opposite the magnetic force (e.g., the direction opposite the target surface) when the base surface 200 of the housing 112 contacts the target surface. In an embodiment, at least one biasing member 212 can take the form of a threaded rod having a head 212h at one end and a tip 212t at the other end. The head 212h can be dimensioned for gripping by a user to rotate the threaded rod and adjust the length which the tip 212t projects outward from, or is recessed from, the base surface 200.

In use, the at least one biasing member 212 can be adjusted such that the tip 206t projects outwards from the base surface 200. The ultrasonic probe 106 is placed, with the at least one biasing member 212 in contact with the target surface. In this manner, the ultrasonic probe 106 is supported by the at least one biasing member 212, inhibiting the base surface 200 from slamming into the target surface. Subsequently, the at least one biasing member 212 can be adjusted to cause the tip 206t to become recessed from the base surface 200. This movement gradually lowers the ultrasonic probe 106 to place the base surface 200 and the sensing surface of the ultrasonic sensor 114 in contact with the target surface. Beneficially, the ability to gradually lower the ultrasonic probe 106 can avoid damage to the outer surface of the target 104 by the ultrasonic probe 106.

The first and second rotatable joint portions 120a, 120b are further illustrated in FIGS. 2A-2B. As shown, the first rotatable joint portion 120a is positioned on the first laterally-facing side 202a of the housing 112 and the second rotatable joint portion 120b is positioned on the second laterally-facing side 206b of the housing 112. When dry coupling ultrasonic probes 106 are arranged circumferentially about the target 104, the first and second rotatable joint portions 120a, 120b of circumferentially adjacent dry coupling ultrasonic probes 106 can couple with one another to form respective first rotatable joints 304.

In an embodiment, the first rotatable joints 304 can be pin joints. As an example, the first rotatable joint portion 120a can have the form of a fork with two prongs extending outward from a first side of the housing 112 (e.g., laterally with respect to the longitudinal axis A). The prongs of the fork can have an eye or opening extending therethrough in the longitudinal direction. The second rotatable joint portion 120b can have the form of a single prong having an eye or opening extending therethrough in the longitudinal direction. The second rotatable joint portion 120b is inserted between the two prongs of the first rotatable joint portion 120a, with the openings of each aligned with one another and a pin is inserted within the aligned openings to form the first rotatable joint 304.

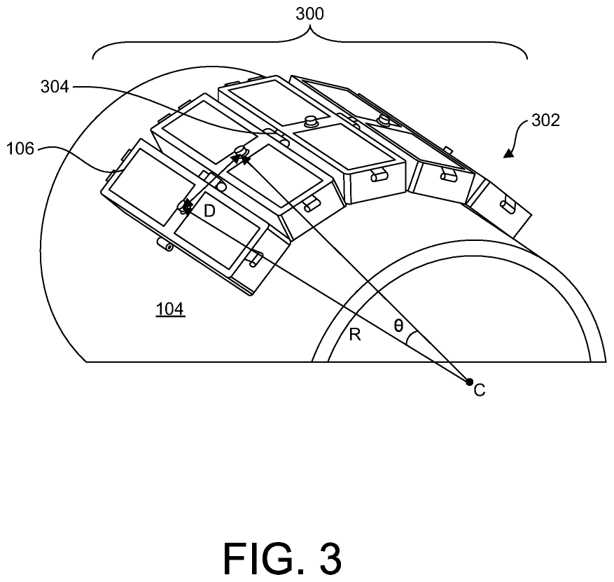

FIG. 3 illustrates a first plurality 300 of the dry coupling ultrasonic probes 106 circumferentially mounted to the target 104. As shown, a first ring 302 is formed by the first plurality 300 of ultrasonic probes 106 coupled together in the circumferential direction by the first rotatable joints 304. By circumferentially coupling the dry coupling ultrasonic probes 106 together, adjacent dry coupling ultrasonic probes 106 can pivot with respect to one another, allowing at least a portion of the base surface 200 of respective dry coupling ultrasonic probes 106 to contact the target surface. In this manner, at least a portion of, and up to all of, the dry coupling ultrasonic probes 106 of the first plurality 300 of ultrasonic probes 106 can be positioned at a predetermined radius R with respect to a center C of the first ring 302. At least a portion of, at up to all of, the dry coupling ultrasonic probes 106 of the first plurality 300 of ultrasonic probes 106 can also be positioned with a predetermined circumferential offset between common reference points of the ultrasonic probes 106 (e.g., about the center of the ultrasonic sensors 114 of the ultrasonic probes 106). The circumferential offset can be an arc length D given by the product of the radius R and an angle θ between the common reference points.

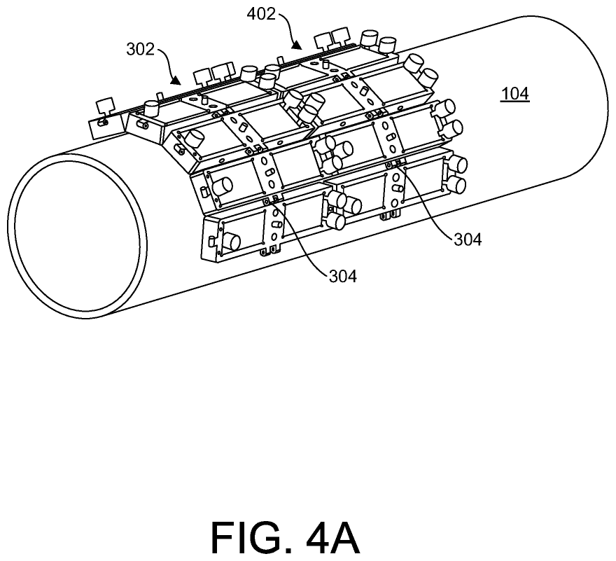

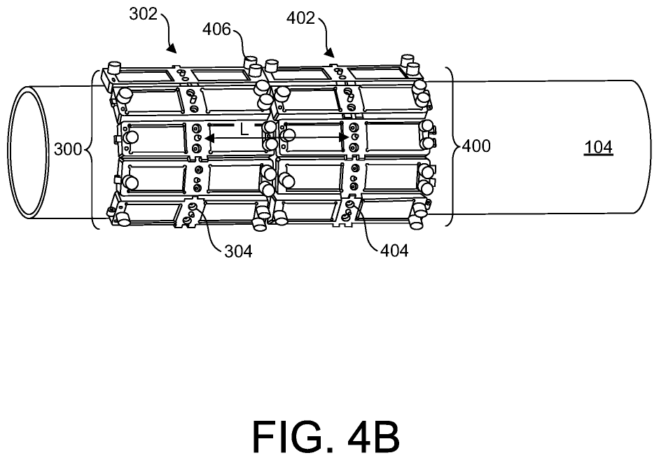

Multiple circumferential rings can be mounted to the target 104 in this manner. As shown in FIGS. 4A-4B, two rings, the first ring 302 along with a second ring 402, are mounted on the target 104 and offset from one another in the longitudinal direction. Similar to the first ring 302, the second ring 402 can be formed from a second plurality 400 of the ultrasonic probes 106 coupled together by respective second rotatable joints 404. The second rotatable joints 404 can be formed by the first rotatable joint portion 120a and the second rotatable joint portion 120b of adjacent ones of the second plurality 400 of ultrasonic probes 106. At least a portion of, and up to all of, the ultrasonic probes 106 of the second plurality 400 of ultrasonic probes 106 can be positioned at a predetermined radial position with respect to a center of the second ring 402. In certain embodiments, the radial position of the first plurality 300 of ultrasonic probes 106 and the second plurality 400 of ultrasonic probes 106 can be approximately equal. That is, the radius of the first ring 302 and the second ring 402 can be approximately equal.

In further embodiments, longitudinally adjacent dry coupling ultrasonic probes 106 of the first ring 302 and the second ring 402 can be coupled to one another by respective third rotatable joints 406. The third rotatable joint 406 can be in the form of a pin joint, similar to the first and second rotatable joints 304, 404. For example, at least a portion of, and up to all of, the ultrasonic probes 106 can further include a third rotatable joint portion 230a positioned on the first longitudinally-facing end 204a of the housing 112 and a fourth rotatable joint portion 230b positioned on the second longitudinally-facing end 204b of the housing 112. As an example, the third rotatable joint portion 230a can have the form of a fork with two prongs extending outward from the first longitudinally-facing end 204a (e.g., approximately parallel with respect to the longitudinal axis A). The prongs of the fork can have an eye or opening extending therethrough in the longitudinal direction. The fourth rotatable joint portion 230b can have the form of a single prong having an eye or opening extending therethrough in the longitudinal direction. The fourth rotatable joint portion 230b can be inserted between the two prongs of the third rotatable joint portion 320a, with the openings of each aligned with one another and a pin is inserted within the aligned openings to form the third rotatable joint 406.

So configured, at least a portion of, and up to all of, the ultrasonic sensors 114 of the dry coupling ultrasonic probes 106 of the first ring 302 is longitudinally distanced from a nearest longitudinally neighboring ultrasonic sensor 114 of the dry coupling ultrasonic sensors 106 of the second ring 402 by a predetermined longitudinal offset L. As an example, when the ultrasonic sensors 114 are arranged at about the midpoint of the length of the dry coupling ultrasonic probes 106, the longitudinal offset L can be approximately the length of the dry coupling ultrasonic sensors 106 plus the length of the third rotatable joint 404. In alternative embodiments, other longitudinal offsets can be employed without limit by reconfiguring the longitudinal position of the ultrasonic sensors within the housing.

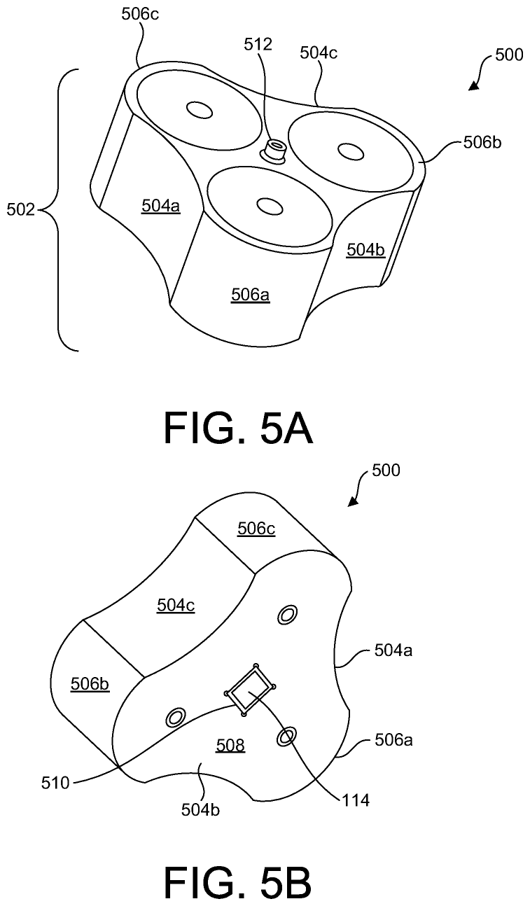

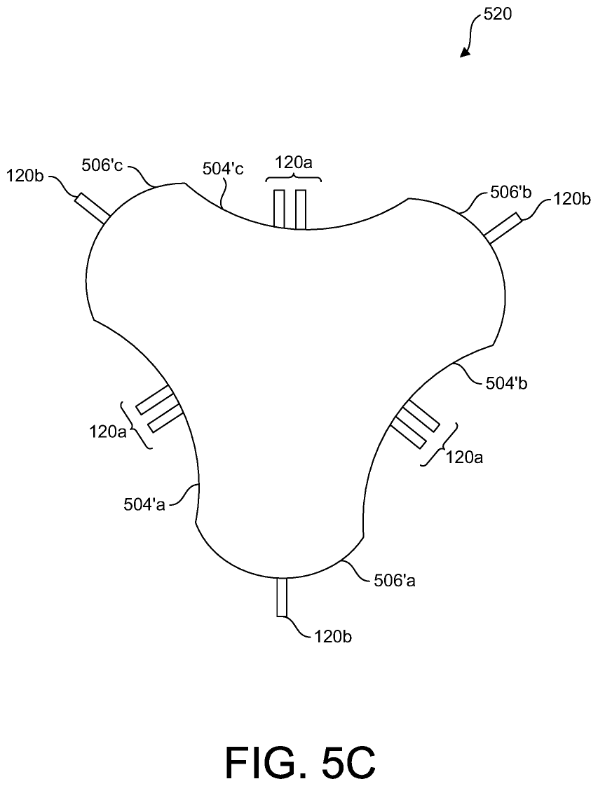

FIGS. 5A-5B illustrate an alternative embodiment of the dry coupling ultrasonic probe 106 in the form of dry coupling ultrasonic probe 500. FIG. 5A is a top-down isometric view and FIG. 5B is a bottom-up isometric view. As shown, the dry coupling ultrasonic probe 500 includes a housing 502 that has a generally triangular shape with curved sides 504a, 504b, 504c interposed between vertices 506a, 506b, 506c and a base surface 508.

The ultrasonic sensor 114 can be positioned adjacent to the base surface 506 (e.g., near to or in contact with). As shown, an opening 510 is formed in the base surface 506 and the ultrasonic sensor 114 is positioned within the opening 510. As an example, a sensing surface (e.g., a surface from which the incident ultrasonic signals 114s are emitted) is approximately flush with the frame. That is, the plane of the sensing surface of the ultrasonic sensor 114 can be approximately co-planar with the base surface 506. The ultrasonic sensor 114 can be further in electrical communication with a connector 512 positioned on an upper surface of the housing 502 for output of the return ultrasonic signals 118s to the analyzer 110 via a high-temperature electrical cable (not shown).

In further embodiments, at least a portion of the base surface 506 is also curved, with a radius of curvature that is selected to match (e.g., approximately equal to) a radius of curvature of the outer surface of the target 104. As a result, when the dry coupling ultrasonic probe 500 is positioned in contact with the target 104, approximately all of the base surface 506 of the housing 502 and the sensing surface of the ultrasonic sensor contacts the outer surface, facilitating dry acoustic coupling of the ultrasonic probe 106 (e.g., the ultrasonic sensor 114) and the target 104.

The dry coupling ultrasonic probe 500 can further include a cover 520 configured to be secured to an upper surface of the dry coupling ultrasonic probe 500 by screws or pins. The cover 520 can have approximately the same shape as the underlying housing 502 and includes the first and second rotatable joint portions 120a, 120b. One of the rotatable joint portions (e.g., the first rotatable joint portion 120a) can extending from the curved cover sides 504′a, 504′b, 504′c, while the other of the rotatable joint portions (e.g., second rotatable joint portion 120b) can extend from the cover vertices 506′a, 506′b, 506′c. As discussed above, when adjacent dry coupling ultrasonic probes 500 are placed adjacent to one another (e.g., a covert vertex of one dry coupling ultrasonic probes adjacent to a curved cover side of a neighboring dry coupling ultrasonic probe), the second rotatable joint portion 120b is inserted between the two prongs of the first rotatable joint portion 120a, with the openings of each aligned with one another and a pin is inserted within the aligned openings to form a rotatable joint.

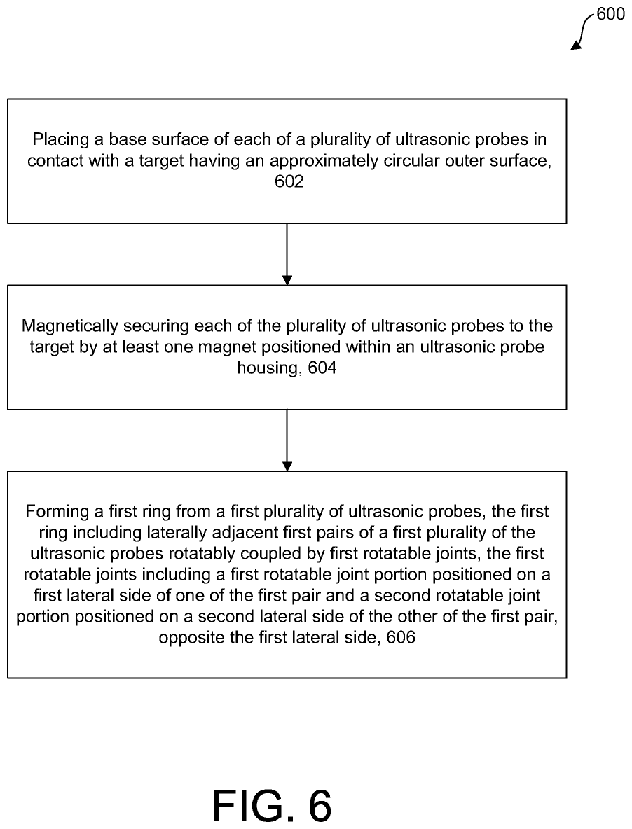

FIG. 6 is flow diagram illustrating one exemplary embodiment of a method 600 for coupling embodiments of the ultrasonic probe 106 to the target 104. As shown, the method 600 includes operations 602-606. It can be appreciated that in alternative embodiments, the method 600 can include greater or fewer operations and the operations can be performed in a different order than illustrated in FIG. 6. The method is discussed below with reference to the dry coupling ultrasonic probe 106 illustrated and described in the context of FIGS. 2A-4B. However, embodiments of the method can be applied to any embodiments of the dry coupling ultrasonic probe without limit (e.g., 500).

In operation 602, the base surface 200 of at least a portion of, and up to all of a plurality of dry coupling ultrasonic probes 106 can be placed in contact with the target 104. The target 104 can have an approximately circular outer surface and the plurality of dry coupling ultrasonic probes 106 can include the housing 112 extending along the longitudinal axis A between the first end 112a and the second end 112b and including the base surface 200. Notably, in an embodiment, a fluid couplant is not interposed between the surface of the target 104 and the base surface 200 of the plurality of dry coupling ultrasonic probes 106.

In operation 604, at least a portion of, and up to all of, the plurality of dry coupling ultrasonic probes 106 can be magnetically secured to the target by at least one magnet 116 positioned within the housing 112. The magnetic force applied by the at least one magnet can be approximately constant up to temperature of about 450° C.

In certain embodiments, a selectively adjustable biasing force can be applied that opposes the magnetic force when the base surface of the housing contacts the target surface.

In operation 606, a first ring 302 can be formed from a first plurality 300 of the dry coupling ultrasonic probes 106. The first ring 302 can include laterally adjacent first pairs of the first plurality 300 of the dry coupling ultrasonic probes 106 rotatably coupled by first rotatable joints 304. The first rotatable joints 304 can include the first rotatable joint portion 120a positioned on the first laterally-facing side 202a of one of the first pair and the second rotatable joint portion 120b can be positioned on a second laterally-facing side 202b of the other of the first pair, opposite the first laterally-facing side 202a. At least a portion of, and up to all of, the first plurality 300 of dry coupling ultrasonic probes 106 can be positioned at a predetermined radial position with respect to the center C of the first ring 302.

In certain embodiments, at least a portion of, and up to all of, the dry coupling ultrasonic probes 106 of the first ring 302 can be longitudinally distanced from a nearest neighbor dry coupling ultrasonic probe 106 of the second ring 402 by a predetermined longitudinal offset.

In operation, the incident ultrasonic signal 114s can be emitted from one or more of the first plurality 300 of dry coupling ultrasonic probes 106. As an example, the incident ultrasonic signal 114s can be being emitted by the ultrasonic sensor 114 secured adjacent to the base surface 200 of the housing 112.

A second ring 402 can also be formed from the second plurality 400 of the dry coupling ultrasonic probes 106. The second ring 402 can include laterally adjacent second pairs of the second plurality 400 of dry coupling ultrasonic probes 106 rotatably coupled by second rotatable joints 404. The second rotatable joints 404 can include the first rotatable joint portion 120a positioned on the first laterally-facing side 202a of one of the second pair and the second rotatable joint portion 120b can be positioned on the second laterally-facing side 202b of the other of the second pair, opposite the first laterally-facing side 202a. At least a portion of, and up to all of, the second plurality 400 of the dry coupling ultrasonic probes 106 can be positioned at a predetermined radial position with respect to the center C of the second ring 402.

The method can also include axially coupling the first ring 302 and the second ring 402 by respective third rotatable joints 406. The third rotatable joints 406 can be formed by a third rotatable joint portion 230a positioned at the first longitudinally-facing end 204a of the first plurality 300 of the dry coupling ultrasonic probes 106 and the fourth rotatable joint portion 230b positioned at the second longitudinally-facing end 204b of the second plurality 400 of dry coupling ultrasonic probes 106.

Exemplary technical effects of the methods, systems, and devices described herein include, by way of non-limiting example coupling ultrasonic probes to magnetic targets without use of an acoustic couplant (e.g., a coupling fluid) between the ultrasonic probe and the target. The housing of the ultrasonic probes allow adjacent ultrasonic probes to be coupled to one another, avoiding the need to use clamps to attach the ultrasonic probes to the target. In this manner, the ultrasonic probes can be employed to test targets at temperatures up to about 450° C. Avoiding the need to use clamps can provide time savings when attaching the ultrasonic probes, as well as easier disassembly and maintenance. Furthermore, without the need for clamps, more locations can be used for placement of ultrasonic probes.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. An ultrasonic probe assembly, comprising:
an ultrasonic probe including,
a housing extending along a longitudinal axis between a first end and a second end and including a base surface;
an ultrasonic sensor secured adjacent to the base surface of the housing, the ultrasonic sensor being configured to emit ultrasonic signals and receive ultrasonic echoes reflected from a target;
at least one magnet secured within the housing and configured to apply a magnetic force urging the base surface into contact with a surface of the target, wherein the magnetic force is sufficient to frictionally maintain the housing at a stationary position with respect to the target surface;
a first rotatable joint portion positioned on a first lateral side of the housing; and
a second rotatable joint portion positioned on a second lateral side of the housing, opposite the first lateral side.

2. The probe assembly of claim 1, further comprising:
a first ring formed from a first plurality of the ultrasonic probes coupled together by respective first rotatable joints;
wherein the first rotatable joints are formed by the first rotatable joint portion and the second rotatable joint portion of adjacent ones of the first plurality of ultrasonic probes; and
wherein at least a portion of the ultrasonic probes of the first plurality of ultrasonic probes are positioned at a predetermined radial position with respect to a center of the first ring.

3. The probe assembly of claim 2, further comprising:
a second ring formed from a second plurality of the ultrasonic probes coupled together by respective second rotatable joints;
wherein the second rotatable joints are formed by the first rotatable joint portion and the second rotatable joint portion of adjacent ones of the second plurality of ultrasonic probes; and
wherein at least a portion of the ultrasonic probes of the second plurality of ultrasonic probes are positioned at a predetermined radial position with respect to a center of the second ring.

4. The probe assembly of claim 3, wherein at least a portion of ultrasonic probe of the first and second plurality of ultrasonic probes further comprise at least one of:
a third rotatable joint portion positioned on the first end of the housing;
a fourth rotatable joint portion positioned on the second end of the housing.

5. The probe assembly of claim 4, wherein the first ring and the second ring are coupled together by respective third rotatable joints, wherein the third rotatable joints are formed by the third rotatable joint portion and the fourth rotatable joint portion of adjacent ones of the first and second plurality of ultrasonic probes, and wherein at least a portion of the ultrasonic sensors of the ultrasonic probes of the first ring are longitudinally distanced from a nearest longitudinally neighboring ultrasonic sensor of the ultrasonic sensors of the second ring by a predetermined longitudinal offset.

6. The probe assembly of claim 1, wherein a Curie temperature of the at least one magnet is greater than or equal to 400° C.

7. The probe assembly of claim 1, wherein the base surface of at least a portion of the ultrasonic probes are approximately flat.

8. The probe assembly of claim 1, wherein the base surface of at least a portion of the ultrasonic probes have a radius of curvature selected to match a radius of curvature of an outer surface of the target.

9. The probe assembly of claim 1, wherein the magnetic force applied by the at least one magnet is between about 100 lbf. to about 200 lbf.

10. The probe assembly of claim 1, wherein the housing is formed in an approximately rectangular shape.

11. The probe assembly of claim 1, the ultrasonic probe further comprising at least one biasing member extending through the base surface of the housing and configured to exert a selectively adjustable biasing force in a direction opposite the magnetic force when the base surface of the housing contacts the target surface.

12. A method for coupling an ultrasonic probe to a target, comprising,
placing a base surface of each of a plurality of ultrasonic probes in contact with a target having an approximately circular outer surface, the plurality of ultrasonic probes including, a housing extending along a longitudinal axis between a first end and a second end and including the base surface;
magnetically securing each of the plurality of ultrasonic probes to the target by at least one magnet positioned within the ultrasonic probe housing;
forming a first ring from a first plurality of ultrasonic probes, the first ring including laterally adjacent first pairs of the first plurality of the ultrasonic probes rotatably coupled by first rotatable joints, the first rotatable joints including a first rotatable joint portion positioned on a first lateral side of one of the first pair and a second rotatable joint portion positioned on a second lateral side of the other of the first pair, opposite the first lateral side, wherein at least a portion of the first plurality of ultrasonic probes are positioned at a predetermined radial position with respect to a center of the first ring.

13. The method of claim 12, further comprising emitting an ultrasonic signal from one or more of the first plurality of ultrasonic probes, the ultrasonic signal being emitted by an ultrasonic sensor secured adjacent to the base surface of the housing.

14. The method of claim 12, further comprising forming a second ring from a second plurality of the ultrasonic probes, the second ring including laterally adjacent second pairs of the second plurality of ultrasonic probes rotatably coupled by second rotatable joints, the second rotatable joints including a first rotatable joint portion positioned on a first lateral side of one of the second pair and a second rotatable joint portion positioned on a second lateral side of the other of the second pair, opposite the first lateral side, wherein at least a portion of the second plurality of ultrasonic probes are positioned at a predetermined radial position with respect to a center of the second ring.

15. The method of claim 14, further comprising axially coupling the first and second rings by respective third rotational joints, wherein the third rotational joints are formed by a third rotatable joint portion positioned at a first end of the first plurality of ultrasonic probes and a fourth rotatable joint portion positioned at a second end of the second plurality of ultrasonic probes.

16. The method of claim 14, wherein at least a portion of the ultrasonic probes of the first ring are longitudinally distanced from a nearest neighbor ultrasonic probe of the second ring by a predetermined longitudinal offset.

17. The method of claim 12, wherein the magnetic force applied by the at least one magnet is approximately constant up to temperature of about 450° C.

18. The method of claim 12, further comprising applying a selectively adjustable biasing force that opposes the magnetic force when the base surface of the housing contacts the target surface.

19. The method of claim 12, wherein a fluid couplant is not interposed between the surface of the target and the base surface of the plurality of ultrasonic probes.
